(19) United States
(12) Patent Application Publication
(10) Pub. No.: US 2010/0017747 A1
(43) Pub. Date: Jan. 21, 2010

(54) Product Viewer

(75) Inventors: Ulziihutag S. Darambazar, Carpentersville, IL (US); Joseph C. Mase, Barrington, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Sagent Pharmaceuticals, Inc., Schaumburg, IL (US)

(21) Appl. No.: 12/505,230

(22) Filed: Jul. 17, 2009

Related U.S. Application Data
(60) Provisional application No. 61/081,415, filed on Jul. 17, 2008.

(51) Int. Cl. G06F 3/048

(52) U.S. Cl. 715/782; 715/800

(57) ABSTRACT

An improved product viewer minimizes the amount of data needed to support a given number of shots or subimages, as well as improved loading time. In an embodiment of the invention, the viewer is a 360° view that has player controls, including, in a further embodiment, a feature set wherein Zoom, rotate, and Pan are usable together in each view. In a further aspect, the disclosed viewer provides continuous rotation of the displayed item, etc., rather than allowing only one complete rotation. In another aspect, the viewer comprises a full screen viewer, and in yet another embodiment the viewer supports panorama views.

### CROSS REFERENCE TO RELATED APPLICATION

This application claims the benefit of U.S. Provisional Application No. 61/081,415, filed Jul. 17, 2008, which is incorporated herein in its entirety.

### BACKGROUND OF THE INVENTION

With the advent of the Internet and widespread Internet connectivity, many commercial outlets, both retail and otherwise, have begun to offer goods, services, and information over the Internet. One difficulty with executing a transaction over a network is the lack of physical proximity of the customer to the product in question while making the purchasing decision. In an attempt to counteract this problem, many commercial outlets provide images or other visual representations of their products on a web page. Although a single still image view of a product is still a fairly common format, some of the more effective representations are those that allow the user to inspect the product from a number of angles. At a rudimentary level, this may be accomplished by posting to the web site a number of still images, each taken from a different angle. In addition, some web sites allow the user to manipulate the image in a more apparently continuous manner, e.g., to rotate and move the product on-screen.

However, such techniques as currently implemented suffer from a number of drawbacks. The best, i.e., most realistic, visual effect is given by a large number of high quality (i.e., high resolution) images. However, it will be appreciated that the speed with which a product representation loads is directly related to the size and number of sub-images. Moreover, the web server storage requirements increase proportionately to both quality and number of images. Thus, maximizing these parameters will unfortunately maximize the storage requirements for the web site and increase the download latency experienced by the user.

When considering this background section, the disclosure and claims herein should not be limited by the deficiencies of the prior art. In other words, the solution of those deficiencies is not a critical limitation of any claim unless otherwise expressly noted in that claim. Moreover, while this background section is presented as a convenience to the reader who may not be of skill in this art, it will be appreciated that this section is too brief to attempt to accurately and completely survey the prior art. The preceding background description is thus a simplified and anecdotal narrative and is not intended to replace printed references in the art. To the extent an inconsistency or omission between the demonstrated state of the printed art and the foregoing narrative exists, the foregoing narrative is not intended to cure such inconsistency or omission. Rather, applicants would defer to the demonstrated state of the printed art.

### SUMMARY OF THE INVENTION

Embodiments of the invention provide an improved object, item, or scene viewer that minimizes the amount of data needed to support a given number of shots or subimages, as well as improved loading time. For example, although current systems require 8 Mb of data for only 12 picture shots, the disclosed system can support twice as many pictures (24) with one eighth (1 mb) of the data.

In another aspect, the disclosed viewer exhibits improved loading time, leading to an improved user experience. Moreover, in an embodiment of the invention, the viewer is a 360° view that has player controls, including, in a further embodiment, a feature set wherein Zoom, rotate, and Pan are usable together in each view. In a further aspect, the disclosed viewer provides continuous rotation of the displayed item, etc., rather than allowing only one complete rotation. In another aspect, the viewer comprises a full screen viewer, and in yet another embodiment the viewer supports panorama views.

### BRIEF DESCRIPTION OF THE DRAWINGS

FIG. 1 is a screen shot of a viewer according to an embodiment of the invention;

FIG. 2 is a flow chart showing the operation of a product viewer in accordance with an embodiment of the invention;

FIG. 3 shows a code section corresponding to a process for retrieving data from an XML file according to an embodiment of the invention, as well as declaring configuration values and defining class variables;

FIG. 4 shows a code section corresponding to a process for manipulating and displaying the cursor via which the user manipulates the image according to an embodiment of the invention;

FIG. 5 shows code 500 corresponding to a process for displaying the item to be viewed, e.g., the product 105, according to an embodiment of the invention;

FIG. 6 shows a code section corresponding to a process for receiving user input to manipulate the item of interest onscreen, e.g., via play and zoom commands, according to an embodiment of the invention;

FIG. 7 shows a code section implementing a process for receiving user input to manipulate the item of interest onscreen according to an embodiment of the invention;

FIG. 8 shows a code section corresponding to a process for receiving user input to manipulate the item of interest onscreen according to an embodiment of the invention;

FIG. 9 shows a code section corresponding to a process for receiving user input to vertically manipulate the item of interest onscreen according to an embodiment of the invention;

FIG. 10 shows a code section corresponding to a process for ending horizontal and vertical move functions as well as zoom functions according to an embodiment of the invention; and

FIG. 11 shows a code section corresponding to a process for loading image data to facilitate a rotation operation in accordance with an embodiment of the invention.

### DETAILED DESCRIPTION OF THE INVENTION

As noted above, embodiments of the invention provide an improved viewer that minimizes the amount of data required to support a given number of shots while providing an improved loading time. It was also noted, inter alia, that the viewer includes in an embodiment a feature set wherein Zoom, rotate, and Pan are usable together in each view.

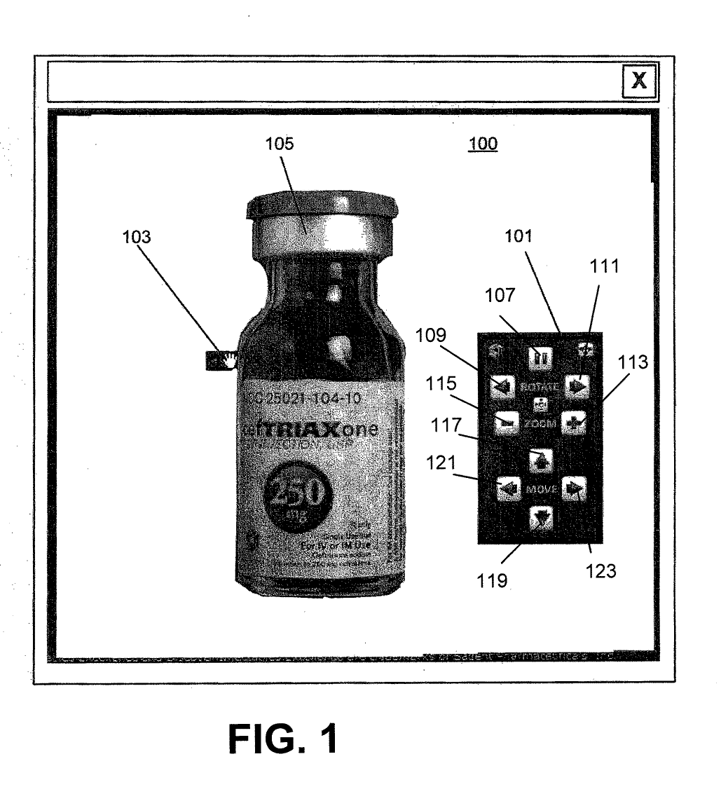

FIG. 1 is a simplified screen shot of a viewer according to an embodiment of the invention, showing the various view controls. As can be seen, the improved viewer user interface (UI) includes a window area 100 within which is presented a view of the product 105. The view can be manipulated by the cursor 103 or the viewer control panel 101. The control panel 101 includes a number of specific controls including a play control 107 that acts to slowly rotate product 105, left and right rotate controls 109, 111, in and out zoom controls 113, 115, and up/down left/right pan controls 117, 119, 121, 123. Of interest, all controls may be used regardless of the state of the other controls. Thus, for example, if the user zooms in on the product 105 via control 113, and pans down via control 119, so that only an enlarged fraction of the product 105 is visible, the product 105 can still be rotated by any means mentioned above without reversing the effects of the prior zoom and pan functions.

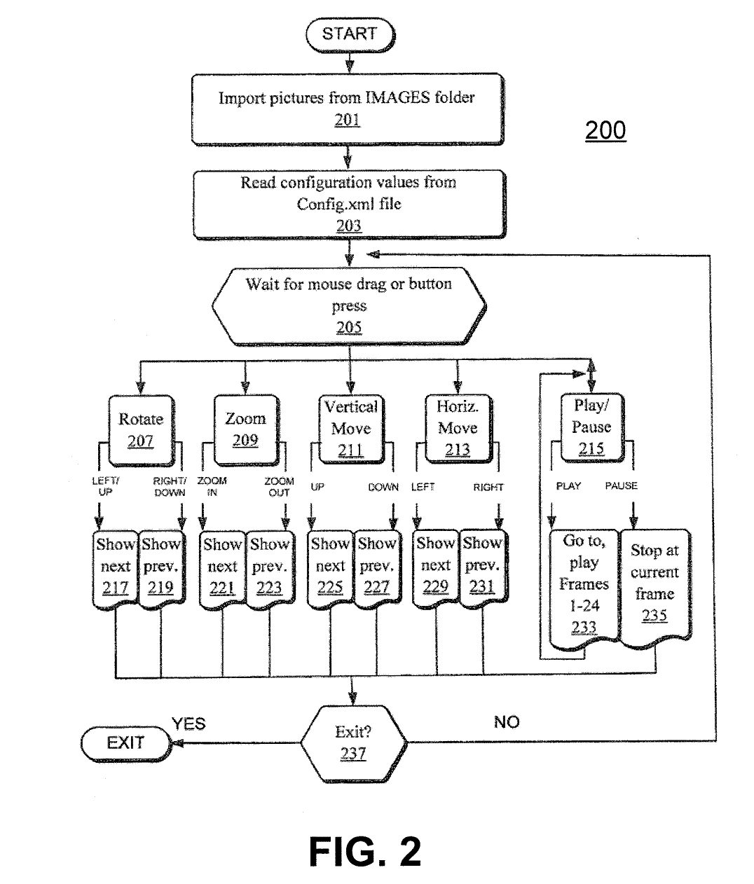

FIG. 2 is a flow chart showing the operation of a product viewer in accordance with an embodiment of the invention. All steps are executed by a computer or other computing device having a processor executing computer-executable instruction read from a computer-readable medium, e.g., a magnetic or optical disk, tape, RAM, ROM, hard drive, etc. As used herein, the term “computer-readable medium” includes human-tangible media such as those listed above and others, and excludes human-intangible media (e.g., acoustic waves, RF waves, electrical signal waves, etc.)

The process 200 begins at stage 201 by importing pictures of the product 105 from an image folder. For example, the images may comprise a series of 24 slightly different views of the product 105 such that when played in sequence, the object appears to rotate. At stage 203, the process 200 reads configuration vales from a file such as a config.xml.file. Next at stage 205, the process 200 awaits mouse drag or button press actions, and branches to one of stages 217-235 depending upon what type of action is received, as can be seen. For example, if a rotate left command (activation of element 109) is received, the process 200 flows to stage 207, and from there to stage 217. Once the required rotation step is accomplished, the process 200 returns to stage 205 to await another input action. The zoom (activation of element 113 or 115), vertical move (activation of element 117 or 119), horizontal move (activation of element 121 or 123), and play/pause actions (activation of element 107) are similarly executed when called for as follows:

Rotate left up to show previous frame

Rotate right down to show next frame

Zoom in to show previous frame

Zoom out to show next frame

Vertical move up to show previous frame

Vertical move down to show next frame

Horizontal move left to show previous frame

Horizontal move right to show next frame

Play to go to play frame 1-24

Pause to stop at current frame

Exit yes to end

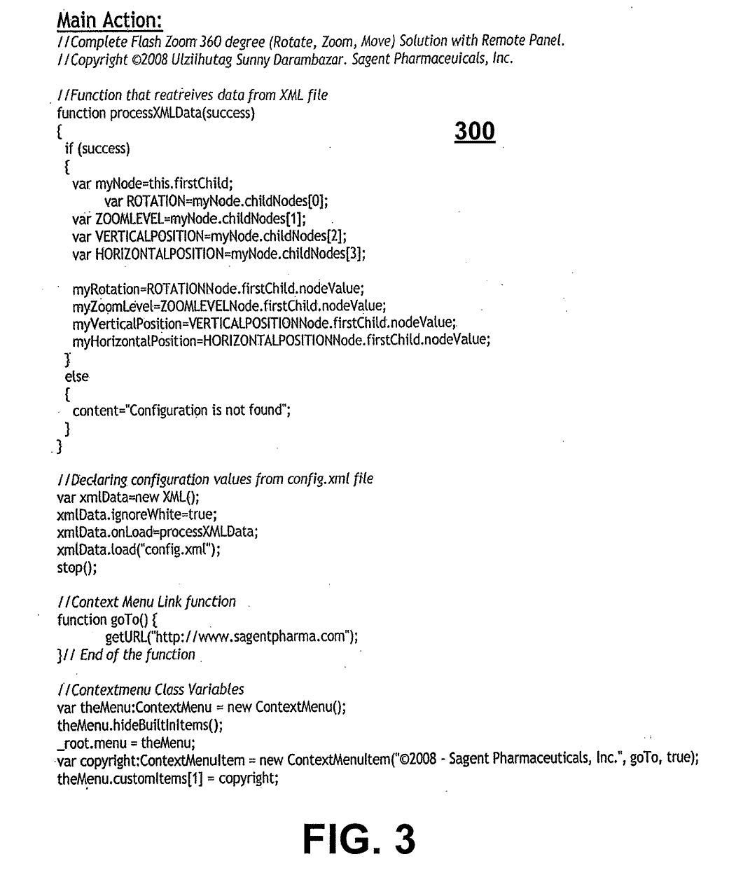

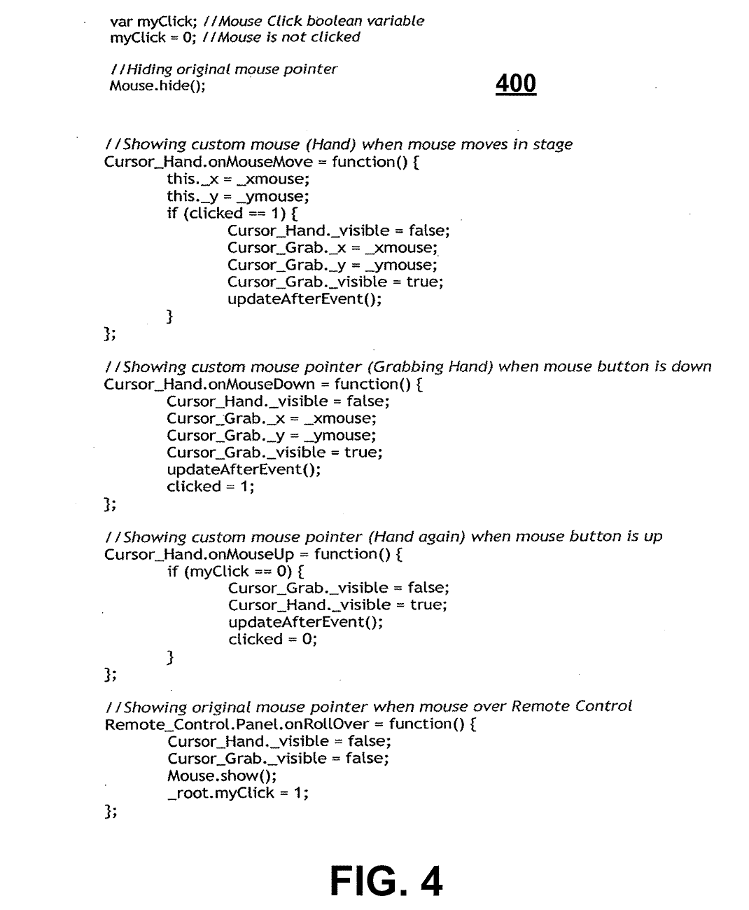

FIGS. 3-9 illustrate exemplary source code for executing various portions of the process shown in FIG. 2. In particular, FIG. 3 shows a section of code 300 corresponding to a process for retrieving data from an XML file according to an embodiment of the invention, as well as declaring configuration values and defining class variables. FIG. 4 continues the code shown in FIG. 3, and also shows a section of code 400 corresponding to a process for manipulating and displaying the cursor via which the user manipulates the image according to an embodiment of the invention.

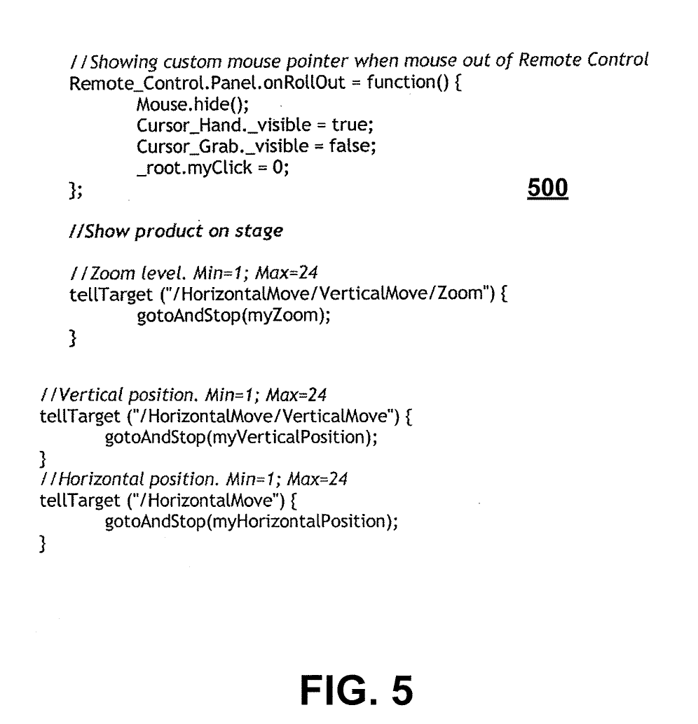

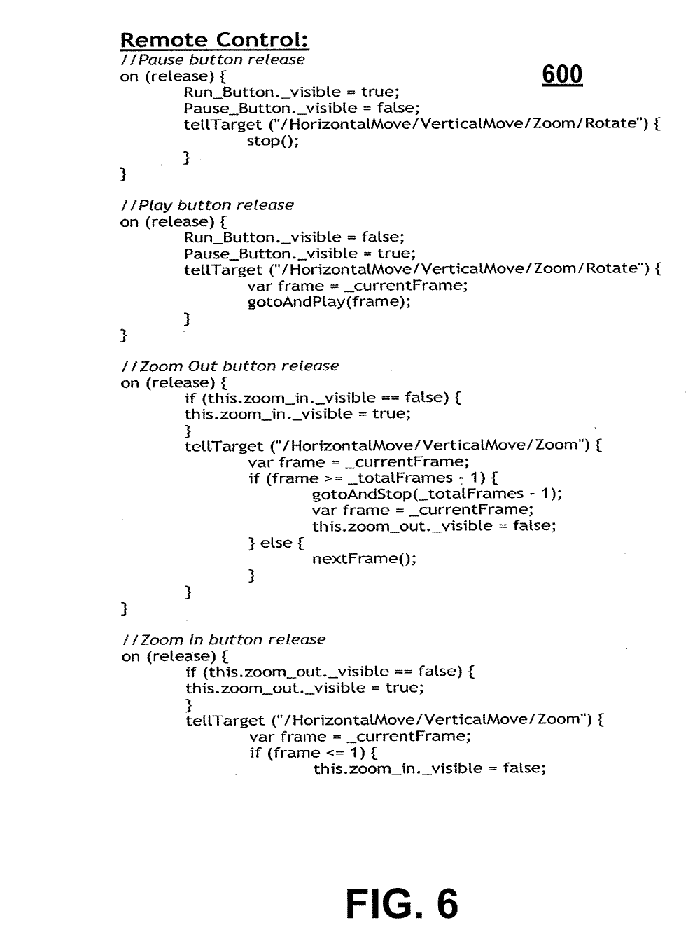

FIG. 5 continues the code of FIG. 4 and also shows code 500 corresponding to a process for displaying the item to be viewed, e.g., the product 105, according to an embodiment of the invention. FIG. 6 shows a section of code 600 corresponding to a process for receiving user input to manipulate the item of interest onscreen, e.g., via play and zoom commands.

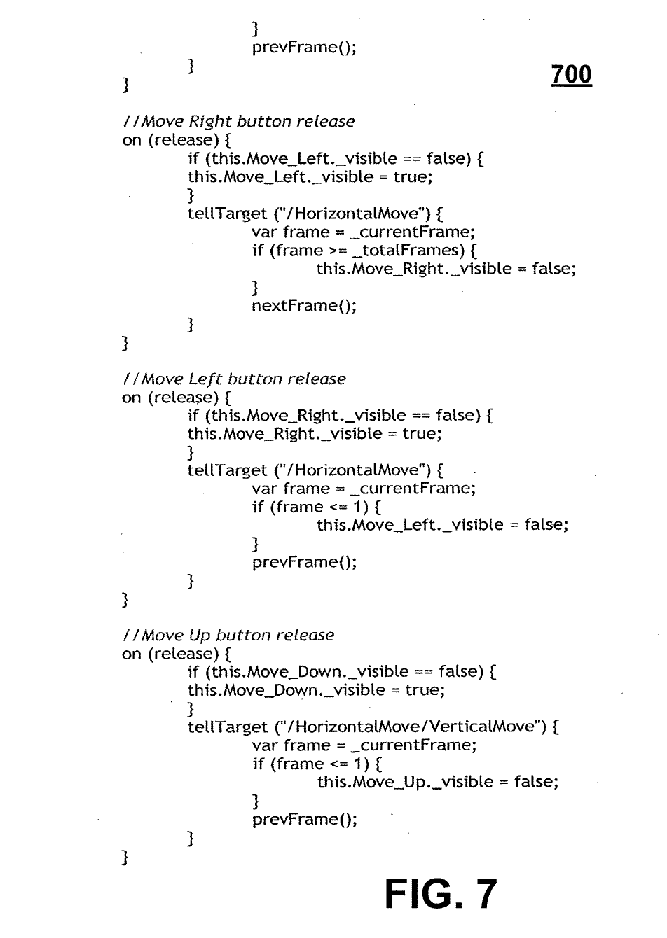

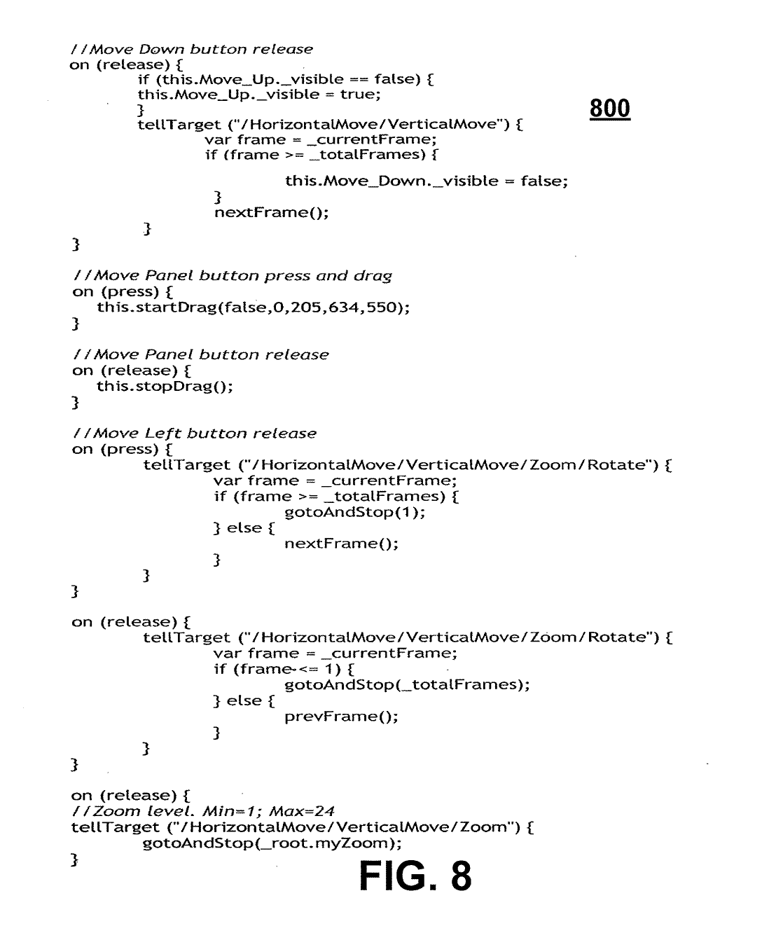

The code section 700 of FIG. 7 implements a process continuing the code of FIG. 6, and also includes further code for receiving user input to manipulate the item of interest onscreen according to an embodiment of the invention. Similarly, FIG. 8 shows code 800 corresponding to a process for receiving user input to manipulate the item of interest onscreen according to an embodiment of the invention.

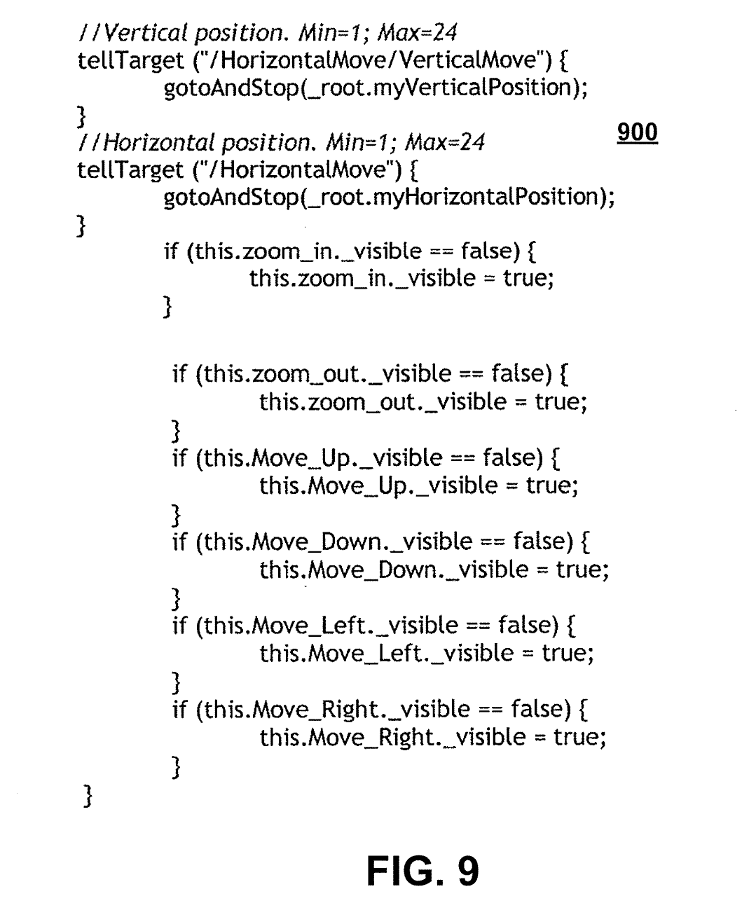

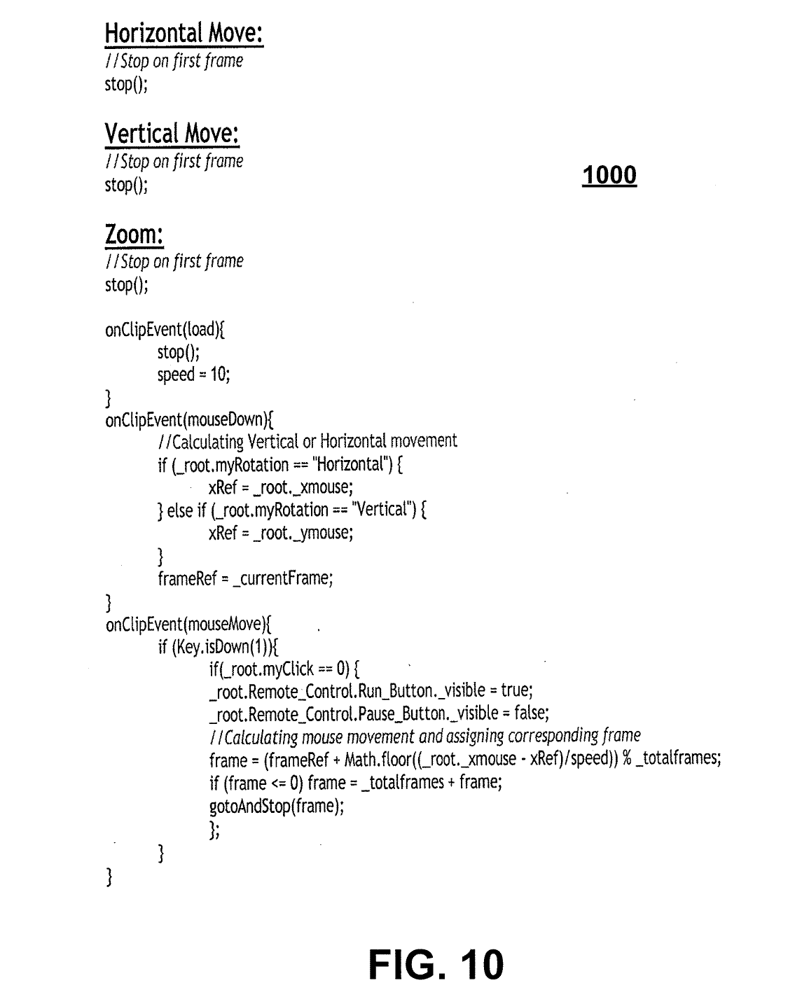

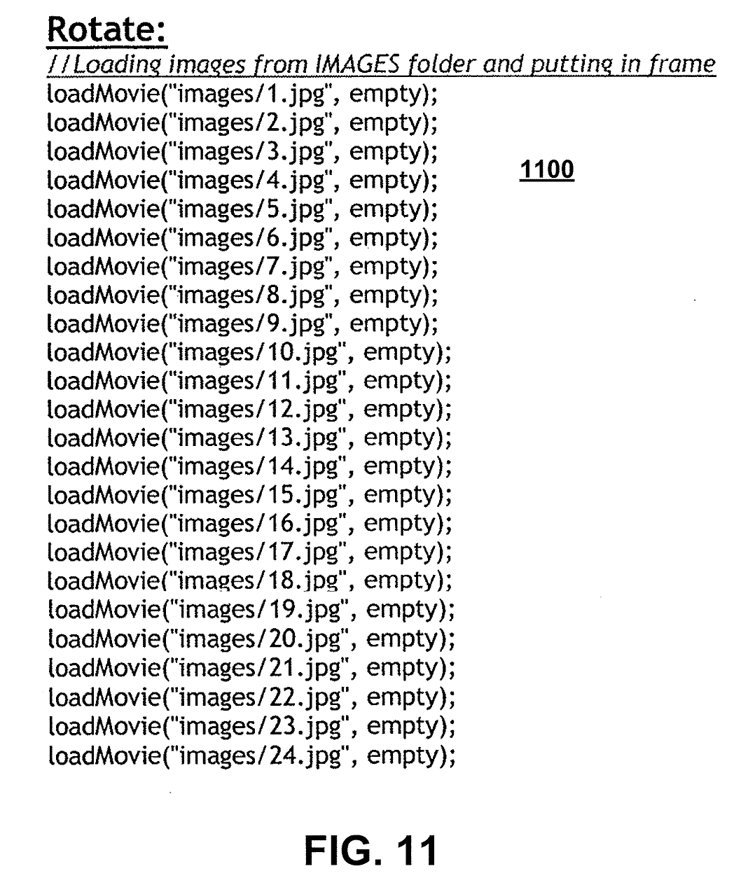

FIG. 9 shows code 900 corresponding to a process for receiving user input to vertically manipulate the item of interest onscreen according to an embodiment of the invention. FIG. 10 shows code 1000 corresponding to a process for ending horizontal and vertical move functions as well as zoom functions according to an embodiment of the invention. Finally, FIG. 11 shows code 1100 corresponding to a process for loading image data to facilitate a rotation operation in accordance with an embodiment of the invention.

In various embodiments, the invention includes a computer-readable storage medium having stored thereon computer-executable instructions for executing the described method, including display of the described user interface and graphic display. It will be appreciated that such computer-readable storage medium may be a hard disc, flash drive, magnetic or optical medium, and so on. Also, it will be appreciate that the computer-executable instructions will be in any suitable computer-readable format and may be derived from source code.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method for operating a product viewer for displaying a product on a screen such that it can be visually rotated, panned, and zoomed, and wherein each such operation does not affect the operation of any other such operation, the method comprising:
creating a series of images of a product to be viewed, the series of images corresponding to a rotational series of views of the product;
loading the series of images to a computer-readable storage medium;
displaying a control panel to a user via a graphical user interface, the control panel having user-selectable controls for performing a plurality of image manipulation operations including at least one image zoom operation, at least one image rotation operation and at least one image translation operation; and
receiving a user-selection of a first one of the user-selectable controls and executing the first one of the user-selectable controls, and receiving a user-selection of a second one of the user-selectable controls and executing the second one of the user-selectable controls without reversing the execution of the first one of the user-selectable controls.

2. The method according to claim 1, wherein receiving a user-selection of a first one of the user-selectable controls further comprises entering a wait state to be exited upon receipt of user selection of one of the user-selectable controls.

3. The method according to claim 1, wherein the at least one image zoom operation includes a zoom in operation for magnifying the image and a zoom out operation of shrinking the image.

4. The method according to claim 1, wherein the at least one image rotation operation includes a rotate right operation and a rotate left operation.

5. The method according to claim 1, wherein the at least one image translation operation includes a left translation operation and a right translation operation.

6. The method according to claim 5, wherein the at least one image translation operation further includes an up translation operation and a down translation operation.

7. The method according to claim 1, wherein the control panel further includes a user-selectable control for playing the series of images in order so as to present the appearance of a continuously rotating image of the product.

8. The method according to claim 7, wherein the user-selectable control for playing the series of images is also selectable to pause the playing of the series of images.

9. The method according to claim 1, wherein the series of images includes 24 images that have a combined size when stored of 1 mb or less.

10. The method according to claim 1, further comprising reading configuration values from a configuration file stored on the computer-readable storage medium before displaying the control panel.

11. A computer-readable storage medium having stored thereon computer-executable instructions for displaying a product on a screen such that it can be visually rotated, panned, and zoomed, and wherein each such operation does not affect the operation of any other such operation, the computer-executable instructions comprising:
instructions for creating a series of images of a product to be viewed, the series of images corresponding to a rotational series of views of the product;
instructions for loading the series of images to a computer-readable storage medium;
instructions for displaying a control panel to a user via a graphical user interface, the control panel having user-selectable controls for performing a plurality of image manipulation operations including at least one image zoom operation, at least one image rotation operation and at least one image translation operation; and
instructions for receiving a user-selection of a first one of the user-selectable controls and executing the first one of the user-selectable controls, and receiving a user-selection of a second one of the user-selectable controls and executing the second one of the user-selectable controls without reversing the execution of the first one of the user-selectable controls.

12. The computer-readable storage medium according to claim 11, wherein the instructions for receiving a user-selection of a first one of the user-selectable controls further comprise instructions for entering a wait state to be exited upon receipt of user selection of one of the user-selectable controls.

13. The computer-readable storage medium according to claim 11, wherein the at least one image zoom operation includes a zoom in operation for magnifying the image and a zoom out operation of shrinking the image.

14. The computer-readable storage medium according to claim 11, wherein the at least one image rotation operation includes a rotate right operation and a rotate left operation.

15. The computer-readable storage medium according to claim 11, wherein the at least one image translation operation includes a left translation operation and a right translation operation.

16. The computer-readable storage medium according to claim 15, wherein the at least one image translation operation further includes an up translation operation and a down translation operation.

17. The computer-readable storage medium according to claim 11, wherein the control panel further includes a user-selectable control for playing the series of images in order so as to present the appearance of a continuously rotating image of the product.

18. The computer-readable storage medium according to claim 17, wherein the user-selectable control for playing the series of images is also selectable to pause the playing of the series of images.

19. The computer-readable storage medium according to claim 11, wherein the series of images includes 24 images that have a combined size when stored of 1 Mb or less.

20. The computer-readable storage medium according to claim 11, further comprising instructions for reading configuration values from a configuration file stored on the computer-readable storage medium before displaying the control panel.
